(19) United States
(12) Patent Application Publication
(10) Pub. No.: US 2021/0101339 A1
(43) Pub. Date: Apr. 8, 2021

(54) 3D PRINTING SYSTEM

(71) Applicant: Collin Boring, Walnut Creek, CA (US)

(72) Inventor: Collin Boring, Walnut Creek, CA (US)

(21) Appl. No.: 17/062,544

(22) Filed: Oct. 2, 2020

Related U.S. Application Data
(60) Provisional application No. 62/911,427, filed on Oct. 7, 2019.

(51) Int. Cl. B29C 64/25; B33Y 30/00; B29C 64/364; B29C 64/118; B28B 1/00; B22F 3/00

(52) U.S. Cl. CPC B29C 64/25; B33Y 30/00; B29C 64/364; B33Y 50/02; B28B 1/001; B22F 3/003; B29C 64/118

(57) ABSTRACT

The present invention related to a portable 3D printing system with advanced thermal management system. The design aims at solving the problem of 3D printing system portability by using a casing member along with shock absorbers or suspension arrangement. The 3D printing system may include a thermal management system which makes it operable in harsh environments. The thermal management system may include a fluid cooling system and heating system which enables the 3D printing system to operate in extreme hot and cold temperatures. The system is safer and smarter using a smart user interface and camera installed inside the 3D printing system.

### BACKGROUND

### Field of the Invention

The present invention relates to field of 3D-printing technology, and, more particularly, to the portable 3D-printer for harsh environment.

### Motivation for the Invention

Three-Dimensional (3D) printing is a process of manufacturing objects by adding various layers of one or other materials through a 3D-printer to obtain a 3D structure based on a 3D model. Now a days, 3D-printing involves a lot of influence from science and technology and that is why has been a field of constant innovation. Specifically, in the process of 3D-printing, a user usually requires a virtual 3D model of an object, one or more material for obtaining the 3D structure based on the 3D model of the object, and a 3D-printer to spray the material to obtain the 3D structure. More often than not, the user requires a 3D-printer, which may exhibit characteristics like easy portability, installation, operability, and so forth.

The 3D-printing system are generally used in various environment at locations and requires to be transported in such locations. There are several conventional 3D-printing systems available today, which are capable to print the objects in certain specific environment, such as in favourable atmospheric conditions. Further, it is found that these conventional existing 3D-printer may be effective in absorbing shocks only up to a certain limit during transportation and can print only in certain limit of temperature range.

Conventional 3D-printer systems may be effective in meeting various requirements but may not be able to address some of the specific problems. For example, the conventional 3D-printing systems may not withstand strong shocks during its transportation and may break after bearing shocks repeatedly. Also, the conventional 3D-printing systems require temperature-controlled environment to operate due to components thermal limitations. As a result, the conventional 3D-printing system may not print in extreme weather conditions. For example, during extreme summers or winters, humidity, or other harsh environmental conditions, such conventional 3D-printing system may impair the printing process due to components operating limitation. Thus, such conventional 3D-printing systems are found to be ineffective to absorb shocks and ineffective in operating extreme weather conditions.

Accordingly, there is a need to overcome various existing problems related to the conventional 3D-printing systems. For example, there is a need for a 3D-printing system that may be capable of being used in extreme weather conditions, such as, during extreme summers or winters, humidity, or other harsh environmental conditions, without impairing the printing process due to components operating limitation. Further, there is a need of such 3D-printing system that may withstand multiple or repetitive shock while transporting or during its usages in harsh geographical landscape.

### SUMMARY

In light of the above problem, an object of the present disclosure is to provide a 3D printing system and/or method to overcome various existing problems related to the conventional 3D-printing systems. For example, an object of the present disclosure is to provide a 3D-printing system and/or method that may be capable of being used in extreme weather conditions, such as, during extreme summers or winters, humidity, or other harsh environmental conditions, without impairing the printing process due to components operating limitation. Further, another object of the present disclosure is to provide a 3D-printing system and/or method that may withstand multiple or repetitive shock while transporting or during its usages in harsh geographical landscape.

Further, additional objects of the present disclosure are to provide a 3D-printing system/method that may be a smart and hybrid. For example, the 3D-printing system/method may incorporate a smart and hybrid user interface that may enable the 3D-printing system/method to be controlled through communicating medium, such as, Wi-Fi, hard wire connection, and on-board screen display. Furthermore, the 3D-printing system/method may incorporate a camera assisted system to capture videos, which can be used for remote diagnosis, artificial intelligence for predicting 3D print failure and for alerts on printing status. In this manner, 3D-printing will be smart, more portable and operable in harsh environments.

Furthermore, an object of the present disclosure is to provide a 3D-printing system/method that may be scalable to any desired size.

In one aspect of the present disclosure, a 3D-printing system comprising:

at least one casing member;

at least one shock absorber or suspension member to hold the at least one casing member;

at least one 3D-printing module supported via the least one shock absorber or suspension member within at least one casing member; and

at least one thermal management system to manage the temperature of the at least one 3D-printing module.

In one embodiment, the 3D-printing module comprises one or more components having:

at least one printing bed;

at least one filament feed tube member;

at least one extruder arrangement;

at least one motion control arrangement;

at least one camera;

at least one communicating medium;

at least one user interface,

wherein said one or more components are arranged and supported via the least one shock absorber or suspension member within at least one casing member to obtain the 3D printing module, and

wherein said one or more components comprises one or more respective shock absorber or suspension member attached thereto.

In one embodiment, the 3D printing module comprises one of filament strings, wires, pellets, powders, and gels as materials for 3D printing.

In one embodiment, the 3D printing module adapted to print plastics, metals, ceramics, and many types of printing materials.

In one embodiment, the at least one shock absorber or suspension member comprises one of a rubber arrangement, a pneumatic arrangement, a hydraulic arrangement, and a shock absorbing material arrangement to customize the shock absorbing capability.

In one embodiment, the at least one shock absorber or suspension member comprises a passive shock absorber or suspension member having a rubber bumpers arrangement.

In one embodiment, the at least one shock absorber or suspension member comprises an active shock absorber or suspension member having a pneumatic arrangement or a hydraulic arrangement to dynamically change shocks to customize response thereof.

In one embodiment, the shock absorbers or suspension system is attached to the 3D-printing module along corners thereof, and wherein, the shock absorbers or suspension system includes brackets and shock absorbers attached to the brackets, wherein the brackets are shaped to complements the shapes of corners of the 3D-printing module, and wherein the shock absorbers are coupled along the brackets at distal ends of the brackets, whereas free ends of the shock absorbers snugly engages with the casing member such that unwanted movements of the 3D-printing module is restricted.

In one another embodiment, a 3D-printing system comprising:

at least one casing member;

at least one shock absorber or suspension member to hold the at least one casing member; and

at least one 3D-printing module supported via the least one shock absorber or suspension member within at least one casing member.

In such embodiment, the at least one shock absorber or suspension member comprises one of a rubber arrangement, a pneumatic arrangement, a hydraulic arrangement, and a shock absorbing material arrangements to customize the shock absorption of at least one 3D-printing module and the at least one of the casing member.

In such embodiment, the at least one shock absorber or suspension member comprises a passive shock absorber or suspension member having a rubber bumpers arrangement to customize shock absorption of at least one 3D-printing module and the at least one of the casing member.

In such embodiment, the at least one shock absorber or suspension member comprises an active shock absorber or suspension member having a pneumatic arrangement or a hydraulic arrangement to dynamically change shocks to customize response thereof to enable shock absorption of at least one 3D-printing module and the at least one of the casing member.

In such embodiment, the shock absorbers or suspension system is attached to the 3D-printing module along corners thereof, and wherein, the shock absorbers or suspension system includes brackets and shock absorbers attached to the brackets, wherein the brackets are shaped to complements the shapes of corners of the 3D-printing module, and wherein the shock absorbers are coupled along the brackets at distal ends of the brackets, whereas free ends of the shock absorbers snugly engages with the casing member such that unwanted movements of the 3D-printing module is restricted.

These aspects of the present disclosure, along with the various features of novelty that characterize the present disclosure, are pointed in the below description. For a better understanding of the present disclosure, its operating advantages, and the specific objects attained by its uses, reference should be made to the accompanying drawing and descriptive matter in which there is illustrated an exemplary embodiment of the present disclosure.

### BRIEF DESCRIPTION OF THE DRAWINGS

Unless otherwise stated, all dimensions are in inches and drawings are not to scale. Several schematic drawings are provided, and images are exemplary prototypes:

FIG. 1 illustrates a diagram which shows the top view of the 3D printing module with thermal management system, in accordance with an exemplary embodiment of the present disclosure;

FIG. 2 illustrates a diagram which shows the angled view of the 3D printing module encapsulated in a casing, in accordance with an exemplary embodiment of the present disclosure;

FIG. 3 illustrates a diagram which shows the various component of the 3D printing module, in accordance with an exemplary embodiment of the present disclosure;

FIG. 4 illustrates a diagram which shows the front view of the 3D printing system, in accordance with an exemplary embodiment of the present disclosure;

FIG. 5 illustrates a diagram which shows the angled view of 3D printing module without casing, in accordance with an exemplary embodiment of the present disclosure;

FIGS. 6A and 6B illustrate diagrams which show an extruder arrangement having a fluid cooling arrangement with a piping system, in accordance with an exemplary embodiment of the present disclosure;

FIGS. 6C, 6D and 6E illustrate diagrams which show dual extruder arrangement and respective tank arrangements, in accordance with an exemplary embodiment of the present disclosure;

FIGS. 7A to 7E illustrate individual shock absorbers or suspension to prevent related impacts on corresponding members, in accordance with an exemplary embodiment of the present disclosure; and

FIG. 7F illustrates solid diagram of the 3D printing system depicting various components, in accordance with an exemplary embodiment of the present disclosure.

Like reference numerals refer to like parts throughout the description of several views of the drawing.

### DESCRIPTION OF THE INVENTION

The exemplary embodiments described herein detail for illustrative purposes are subject to many variations in implementation. The present disclosure provides a 3D-printing system and/or method that may be used in extreme weather conditions, such as, during extreme summers or winters, humidity, or other harsh environmental conditions. Further, the present disclosure provides a 3D-printing system and/or method that may withstand multiple or repetitive shock while transporting or during its usages in harsh geographical landscape. It should be emphasized, however, that the present disclosure is not limited to a system and/or method of portable 3D printing technology with advanced thermal management system. It is understood that various omissions and substitutions of equivalents are contemplated as circumstances may suggest or render expedient, but these are intended to cover the application or implementation without departing from the spirit or scope of the present disclosure.

The terms “a” and “an” herein do not denote a limitation of quantity, but rather denote the presence of at least one of the referenced items.

The terms “having”, “comprising”, “including”, and variations thereof signify the presence of a component.

The present disclosure provides a 3D printing system and/or method to overcome various existing problems related to the conventional 3D-printing systems. For example, the present disclosure provides a 3D-printing system and/or method that may be capable of being used in extreme weather conditions, such as, during extreme summers or winters, humidity, or other harsh environmental conditions, without impairing the printing process due to components operating limitation. Further, the present disclosure provides a 3D-printing system and/or method that may withstand multiple or repetitive shock while transporting or during its usages in harsh geographical landscape.

Further, the present disclosure provides a 3D-printing system/method that may be a smart and hybrid. For example, the present disclosure provides a 3D-printing system/method that may incorporate a smart and hybrid user interface that may enable the 3D-printing system/method to be controlled through Wi-Fi, hard wire connection, and on-board screen display. Furthermore, the present disclosure provides, the 3D-printing system/method that may incorporate a camera assisted system to captured videos, which can be used for remote diagnosis, artificial intelligence for predicting 3D print failure and for alerts on printing status. In this manner, the present invention is 3D-printing will be smart, more portable and operable in harsh environment.

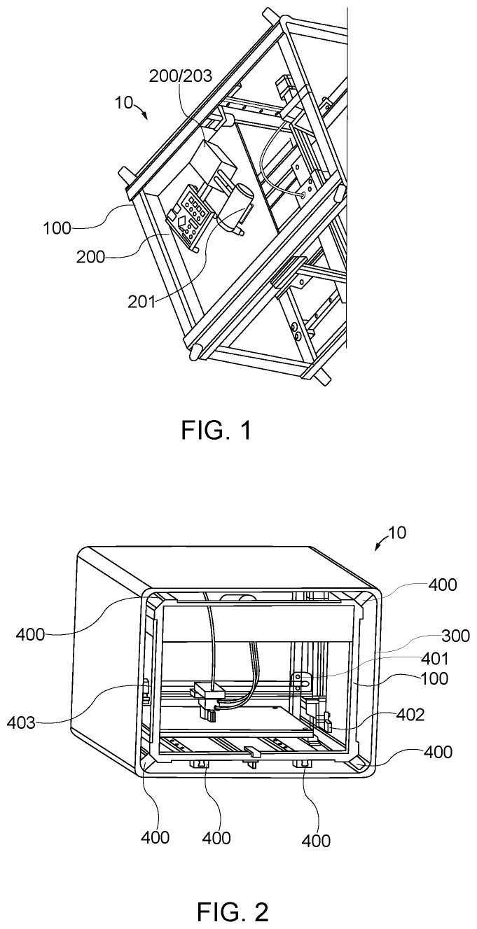

The embodiments of the 3D-printing system/method will now be explained in conjunction with FIGS. 1-7F as below.

Now referring to FIG. 1, which provides a top view of a 3D printing module 100 of a 3D printing system 10 with a thermal management system 200, in accordance with an exemplary embodiment of the present disclosure. In the example FIG. 1, the 3D printing module 100 comprises a thermal management system 200 which may include a pump 201, a cooling system 202, and a heating system 203. However, without departing from the scope of the present disclosure, the thermal management system 200 may also include various components, such as piping system, housing, coupling members, and so forth. The cooling system 202 may provide cold liquid/water to critical components inside the 3D printing module 100 to facilitate heat transfer from the critical component. The action of heat transfer through the cold liquid/water cools the critical components and stops the components to cross the high operating temperature threshold. The cooling system 202 may be controlled using a thermostat that automatically activates itself, which in turn activates the thermal management system 200 upon the requirement. The cooling system 202 may be capable to drop the liquid/water temperature below the ambient air temperature. This is important for 3D printing systems 10 when the temperature for such system is required to be lower than the ambient temperature. The pump 201 may be used to pump the fluid through the critical component as and when cooling is required. In one example, the fluid for cooling the critical components may be water, however, without departing from the scope of the present disclosure, the fluid may be any other heat absorbing fluid. Further, to negate the adverse effect of extreme low temperature conditions on the 3D printing system 10, the heating system 203 may be installed nearby critical components. The heating system 203, in low temperature condition, may transfer heat to the critical components to pre-heat the 3D printing system 10. Heat transfer action by the heating system 10 to the critical components stops the components to cross the low operating temperature threshold. The inclusion of thermal management system 200 in the 3D printing system 10 may increase the efficacy of the 3D printing system 10 in extreme weather conditions.

Now referring to FIG. 2, which provides angled view of the 3D printing system 10, in accordance with an exemplary embodiment of the present disclosure. In the example FIG. 2, a casing member 300 is shown which may include plurality of shock absorber or suspension system 400. The combination of casing member 300 and shock absorber or suspension system 400 encapsulates the 3D printing module 100. The shock absorber or suspension system supports 400 the 3D printing module 100 from all the sides. The casing member 300 makes the 3D printing system 10 robust and durable, whereas shock absorber or suspension 400 makes 3D printing system 10 capable of withstanding strong shocks. Such an arrangement protects the entire 3D printing system 10 from impacts experienced during portability, installation, operability, and so forth. Further, each of the electrical components or other components such as printing bed; filament feed tube member; extruder arrangement; motion control arrangement; camera; communicating medium; user interface, inside the 3D printing system 10 may also include individual shock absorbers or suspension, such as shock absorbers 401, 402, 403 to prevent related impacts. In one embodiment, the casing member 300 may be a rigid and firm structure made of thick metals using brackets and frames which makes the 3D printing system safe for the transportation in harsh geographical landscapes.

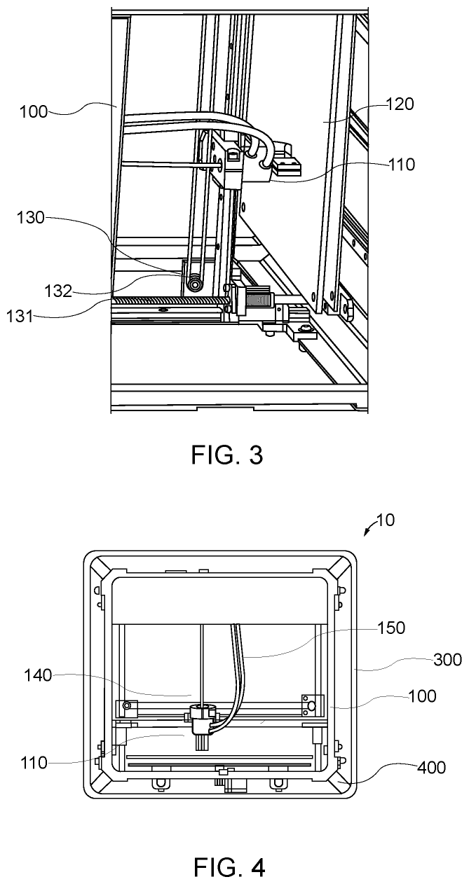

Now referring to FIG. 3, which shows the various component of the 3D printing module 100, in accordance with an exemplary embodiment of the present disclosure. In the one embodiment of the disclosure, the 3D printing module 100 adapted to print plastics, metals, ceramics, and many types of printing materials. As shown, example FIG. 3 illustrates the 3D printing module 100 including an extruder arrangement 110, a printing bed 120, and a motion control arrangement 130. The extruder arrangement 110 may further include a motor, a gear arrangement, a heat sink member, a thermistor/thermocouple member, a heating block member, a nozzle member, and an extruder cooling system. The extruder arrangement 110 may be a part where most of the printer's technology exists and where most of the printer's work is done. The extruder arrangement 110 may include two ends, a hot end and a cold end. The extruder arrangement may draw one of filament strings, wires, pellets, powders, and gels as materials for 3D printing from the cold end through a motor and pushes the filament forward at the hot end. At the hot end, the printing material melts and further sprayed out for printing on the printing bed 120. The printing bed 120 is a surface over which printing is done. The printing bed 120 facilitates sticking of the filament over itself and once printing is done it further facilitates removal of printed object from its own surface. There are different kinds of printing bed 120 and one can choose the type of printing bed 120 based on his/her requirement. The printing over the printing bed 120 is done according to the model of the object which is to be printed.

Further, the example FIG. 3 shows the motion control arrangement 130. The motion control arrangement 130 may be a part of 3D printing module 100 which enables the extruder to move along X, Y and Z axes. The motion control arrangement 130 may enable extruder to move over the printing bed 120 in required dimension with required speed. The example FIG. 3 shows the motion control arrangement 130 which includes a plurality of leadscrews 131 for the Z-axis (vertical) movement and belt-sprocket arrangement 132 for the X and Y axes (horizontal) movement. The X & Y axis can also use lead screws or belts.

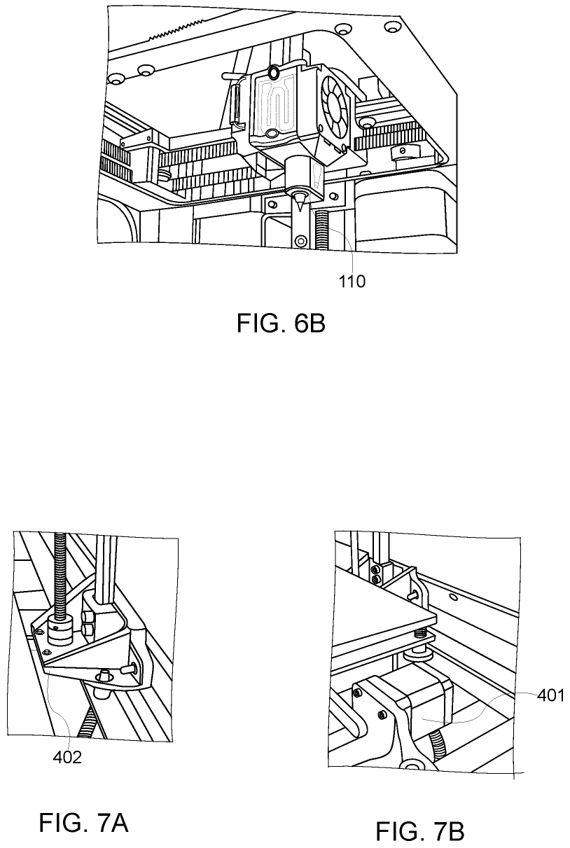

Now referring to FIG. 4, which shows the front view of the 3D printing system 10, in accordance with an exemplary embodiment of the present disclosure. The example FIG. 4 shows the casing member 300 and the shock absorbers or suspension system 400 encapsulating the 3D printing module 100, and the 3D printing module 100 containing different component. The working of the casing member 300 and the shock absorbers or suspension system 400 is discussed earlier in the description of FIGS. 1 and 2. The 3D printing module 100 as shown in FIG. 4 illustrates the printing bed member 120, the extruder arrangement 110, a filament feed tube member 140, and the motion control arrangement 130. The extruder arrangement 110 via the piping system 150 circulated the fluid to maintain the optimum operating temperature during the printing process to maintain its efficiency. The extruder arrangement 110 may be further discussed herein with reference to FIG. 6. In one embodiment, the filament feed tube member 140 may be a rod like structure which feeds the 3D-printing material to the extruder arrangement 110.

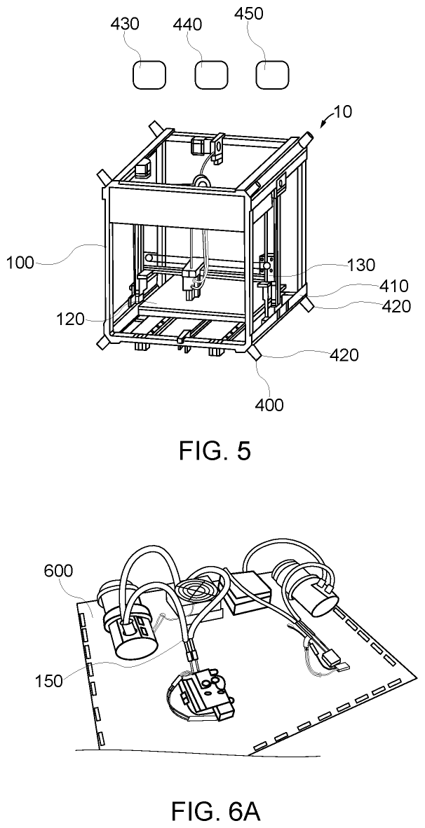

Now referring to FIG. 5, which shows an angled view of 3D printing module 100 without casing 300, in accordance with an exemplary embodiment of the present disclosure. The example FIG. 5 illustrates the 3D printing module 100 depicting the extruder arrangement 110, the printing bed 120, and the motion control arrangement 130 as described herein with reference to FIGS. 1 to 4. FIG. 5 also illustrates the shock absorbers or suspension system 400 attached to the 3D-printing module 100 along the corners thereof. As illustrated, the shock absorbers or suspension system 400 includes brackets 410 and shock absorbers 420 attached to the brackets. The brackets 410 are shaped to complements the shapes of corners of the 3D-printing module 100. Further, the shock absorbers 420 are coupled along the brackets 410, such as shown in FIG. 5, at distal ends of the brackets 410. Free ends of the shock absorbers 420 snugly engages with the casing member 300 such that unwanted movements of the 3D-printing module 100 is restricted.

In one embodiment, the at least one shock absorber or suspension member 400 may include shock absorbers 420 that may be one of a rubber arrangement, a pneumatic arrangement, a hydraulic arrangement, and a shock absorbing material arrangement to customize the shock absorbing capability.

In one embodiment, the at least one shock absorber or suspension member 400 may include shock absorbers 420 that may be a passive shock absorber or suspension member having a rubber bumpers arrangement.

In one embodiment, the at least one shock absorber or suspension member 400 may include shock absorbers 420 that may be an active shock absorber or suspension member having a pneumatic arrangement or a hydraulic arrangement to dynamically change shocks to customize response thereof.

FIG. 5 also illustrates at least one camera 430; at least one communicating medium 440; and at least one user interface 450 coupled to the 3D printing system 10.

Now referring to FIGS. 6A and 6B, which show the extruder arrangement 110 having a fluid cooling arrangement 600 with the piping system 150, in accordance with an exemplary embodiment of the present disclosure. As discussed earlier in the description of FIG. 3, the extruder arrangement 110 is the major part of the 3D printing system 10. The extruder arrangement 110 may include multiple part and work continuously to print a 3D object based on a 3D model. Sometimes, it takes hours by 3D printing system 10 to print an object, due to which it is necessary for the extruder arrangement 110 to run for that period of time. While running for enormous amount of time, the extruder arrangement 110 usually gets heated and becomes prone to component failure. To keep extruder arrangement 110 running for longer duration the fluid cooling arrangement 160 with the piping system 150, as can be seen in FIGS. 6A and 6B, is attached to the extruder arrangement 110 to supply fluid into the extruder arrangement 110 for heat transfer. The piping system 150 may be capable of circulating fluid in and out of the extruder arrangement 110. The fluid circulating through the extruder arrangement 110 extracts excessive heat from the extruder arrangement 110 to maintain temperature of the extruder arrangement 110.

Further, FIGS. 6C, 6D and 6E illustrate diagrams which show dual extruder arrangement 110 and respective tank arrangements 112 and 114 as seen in FIGS. 6D and 6E.

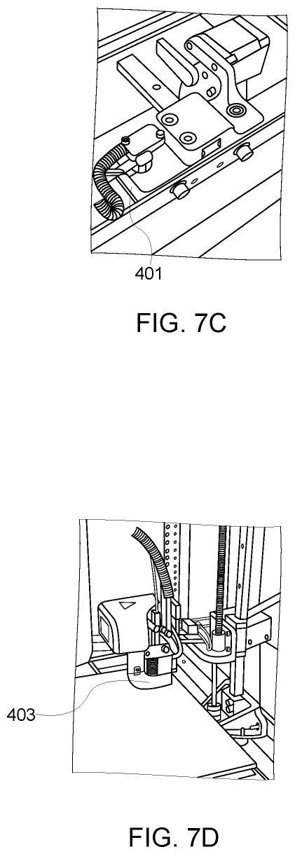

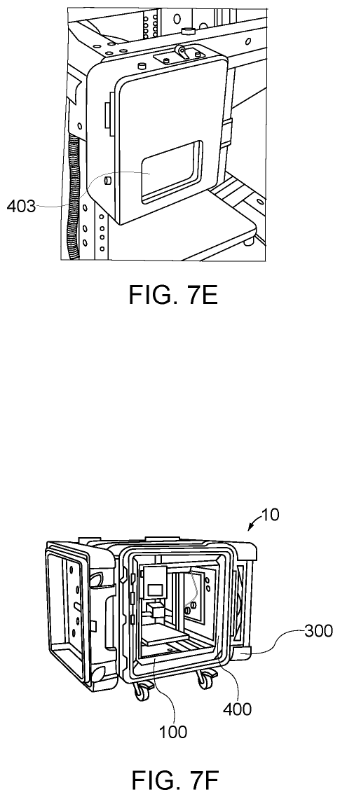

Referring to FIGS. 7A to 7E, which illustrate individual shock absorbers or suspension, such as shock absorbers 401, 402, 403 to prevent related impacts on corresponding members. FIG. 7F illustrates solid diagram of the 3D printing system 10 depicting various components.

In one embodiment of the disclosure, the 3D printing system 10 may include locks that may be installed on a linear bearing shafts of the 3D printing system 10 which negates the sliding and slipping of 3D printing system during the time of shipping.

In the one embodiment of the disclosure, the 3D printing system 10 may be a is modular and scalable to any size rugged case by using longer linear rails.

In the one embodiment of the disclosure, the 3D printing system 10 may include a user interface, such as the user interface 450, as shown in FIG. 5, that can be controlled by a communicating device 450 such as Wi-Fi, hard wire connection, or even an on-board screen display.

In the one embodiment of the disclosure, the 3D printing system 10 may include a camera, such as the camera 430 as shown in FIG. 5, inside is connected to the internet and monitors the 3D printing. Video feed obtained by the camera 430 can be used to remote diagnosing, artificial intelligence for predicting 3D print failures, and alerts on printer status.

In the one embodiment of the disclosure, the motion control arrangement may be a different mechanical motion control arrangement.

Applicant created and perfected various prototypes in determining the ideal form, format, and manufacturing materials and subsequently conducted experimentation of the prototypes in controlled circumstances. After eliminating a few potential manufacturing materials, designs and methods, Applicant identified the best-suited material, which proved to be economical, sturdy and flexible to obtain the 3D printing system. Similarly, the 3D printing system of the invention and overall design thereof underwent several iterations, in order to accomplish functional, comfortable, economical, simple, easy-to-use design, which further featured universal means of the 3D printing system in such a way that it may be capable of being used in extreme weather conditions, such as, during extreme summers or winters, humidity, or other harsh environmental conditions, without impairing the printing process due to components operating limitation. Further, the present disclosure provides a 3D-printing system and/or method that may withstand multiple or repetitive shock while transporting or during its usages in harsh geographical landscape. However, Applicant further submits that by the time the product is finalized, there may be various other modification and alterations in designs of the 3D printing system, and that the Applicant claims that this applicant is intending to include those modification and alternation in design.

The present invention should not be construed to be limited to the configuration of the method and system as described herein only. Various configurations of the system are possible which shall also lie within the scope of the present disclosure.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, and to thereby enable others skilled in the art to best utilize the present disclosure and various embodiments with various modifications as are suited to the particular use contemplated. It is understood that various omissions and substitutions of equivalents are contemplated as circumstances may suggest or render expedient, but such omissions and substitutions are intended to cover the application or implementation without departing from the spirit or scope of the present disclosure.

What is claimed is:

1. A 3D-printing system comprising:
at least one casing member;
at least one shock absorber or suspension member to hold the at least one casing member;
at least one 3D-printing module supported via the least one shock absorber or suspension member within at least one casing member; and
at least one thermal management system to manage the temperature of the at least one 3D-printing module.

2. The 3D-printing system of claim 1, wherein the 3D-printing module comprises one or more components having:
at least one printing bed;
at least one filament feed tube member;
at least one extruder arrangement;
at least one motion control arrangement;
at least one camera;
at least one communicating medium;
at least one user interface,
wherein said one or more components are arranged and supported via the least one shock absorber or suspension member within at least one casing member to obtain the 3D printing module, and
wherein said one or more components comprises one or more respective shock absorber or suspension member attached thereto.

3. The 3D-printing system of claim 2, wherein the 3D printing module comprises one of filament strings, wires, pellets, powders, and gels as materials for 3D printing.

4. The 3D-printing system of claim 2, wherein the 3D printing module adapted to print plastics, metals, ceramics, and many types of printing materials.

5. The 3D-printing system of claim 1, wherein the at least one shock absorber or suspension member comprises one of a rubber arrangement, a pneumatic arrangement, a hydraulic arrangement, and a shock absorbing material arrangement to customize the shock absorbing capability.

6. The 3D-printing system of claim 1, wherein the at least one shock absorber or suspension member comprises a passive shock absorber or suspension member having a rubber bumpers arrangement.

7. The 3D-printing system of claim 1, wherein the at least one shock absorber or suspension member comprises an active shock absorber or suspension member having a pneumatic arrangement or a hydraulic arrangement to dynamically change shocks to customize response thereof.

8. The 3D-printing system of claim 1, wherein the shock absorbers or suspension system is attached to the 3D-printing module along corners thereof, and wherein, the shock absorbers or suspension system includes brackets and shock absorbers attached to the brackets, wherein the brackets are shaped to complements the shapes of corners of the 3D-printing module, and wherein the shock absorbers are coupled along the brackets at distal ends of the brackets, whereas free ends of the shock absorbers snugly engages with the casing member such that unwanted movements of the 3D-printing module is restricted.

9. A 3D-printing system comprising:
at least one casing member;
at least one shock absorber or suspension member to hold the at least one casing member; and
at least one 3D-printing module supported via the least one shock absorber or suspension member within at least one casing member.

10. The 3D-printing system of claim 9, wherein the at least one shock absorber or suspension member comprises one of a rubber arrangement, a pneumatic arrangement, a hydraulic arrangement, and a shock absorbing material arrangements to customize the shock absorption of at least one 3D-printing module and the at least one of the casing member.

11. The 3D-printing system of claim 9, wherein the at least one shock absorber or suspension member comprises a passive shock absorber or suspension member having a rubber bumpers arrangement to customize shock absorption of at least one 3D-printing module and the at least one of the casing member.

12. The 3D-printing system of claim 9, wherein the at least one shock absorber or suspension member comprises an active shock absorber or suspension member having a pneumatic arrangement or a hydraulic arrangement to dynamically change shocks to customize response thereof to enable shock absorption of at least one 3D-printing module and the at least one of the casing member.

13. The 3D-printing system of claim 9, wherein the shock absorbers or suspension system is attached to the 3D-printing module along corners thereof, and wherein, the shock absorbers or suspension system includes brackets and shock absorbers attached to the brackets, wherein the brackets are shaped to complements the shapes of corners of the 3D-printing module, and wherein the shock absorbers are coupled along the brackets at distal ends of the brackets, whereas free ends of the shock absorbers snugly engages with the casing member such that unwanted movements of the 3D-printing module is restricted.
